(19) United States
(12) Patent Application Publication
(10) Pub. No.: US 2010/0177043 A1
(43) Pub. Date: Jul. 15, 2010

(54) FLIP-OPERATION MOUSE DEVICE

(76) Inventor: Tzu-Hung CHEN, Hsinchu (TW)

Correspondence Address: Muncy, Geissler, Olds & Lowe, PLLC, 4000 Legato Road, Suite 310, FAIRFAX, VA, 22033, US

(21) Appl. No.: 12/437,192

(22) Filed: May 7, 2009

(30) Foreign Application Priority Data
Jan. 10, 2009 (TW) 98200403

(51) Int. Cl. G06F 3/033

(52) U.S. Cl. 345/163

(57) ABSTRACT

A flip-operation mouse device includes a housing, a sliding surface structure, a moving plate, a displacement-detecting device and a control unit. By moving around the moving plate on the upper side of the sliding surface structure and using the displacement-detecting device mounted under the sliding surface structure and on the opposite side relative to the moving plate, the movement and direction of the moving plate and hence the cursor position can be effectively controlled. Furthermore, by moving the moving plate up and down to turn on or off the displacement-detecting device can enable the operation of the moving plate within a smaller space repetitively, so as to effectively extend the maximum equivalent operation area of the moving plate. Therefore, the above-mentioned flip-operation mouse device is able to be operated within a relatively smaller space and can precisely and easily control the cursor position.

### BACKGROUND OF THE INVENTION

1. Field of the Invention

The present invention generally relates to a computer mouse device, and more particularly to a flip-operation mouse device which can be easily operated in a similar way as the conventional sliding-type mouse without the need to slide on a fixed surface for precisely controlling the position of a cursor on a monitor.

2. Description of the Prior Art

In the information age, the computer has become an indispensable tool in our daily life and the mouse is one of the most commonly used input devices for operating computer. According to the ways of operation, the mouse can be generally classified into two categories: the sliding type and the stationary type. Referring to FIG. 1, the operation of the sliding-type mouse 10 is by sliding the mouse on a fixed surface 2. A displacement-detecting device 11 is used to detect the movement and the direction of the sliding-type mouse 10 with respect to the fixed surface 2 for controlling the cursor position on the computer monitor and the button 12 and the wheel button 13 are used for entering commands. The applications of the sliding-type mouse 10 is limited due to the requirement of larger operating space.

On the other hand, the stationary type mouses, such as, track ball, track stick, touch pad or touch screen etc. used in a notebook computer, have the advantage of using less operating space, but the moving speed and position of the cursor are much more difficult to be precisely controlled. Therefore, many notebook computer users are still used to plug an external sliding-type mouse to control the cursor position.

Furthermore, although many types of existing wireless hand-held mouse which don't need to slide on a fixed surface for resolving the aforesaid problem that the notebook computer still requires an external sliding-type mouse for more convenient operation and all of them still use the track ball, track stick or gyroscope to control the cursor position. Therefore, the fundamental problems that the cursor position can not be precisely controlled and the operation is not user-friendly still remain.

Therefore, how to operate the mouse with precise control of the cursor position but without the requirement of sliding the mouse on a fixed larger surface is the ultimate goal of the present invention.

### SUMMARY OF THE INVENTION

The present invention is aimed at the flip-operation mouse device including a moving plate whose movement and direction can be detected by using a displacement-detecting device kept stationary for controlling the cursor position. Therefore, the flip-operation mouse device, according to one embodiment, may be operated within a relatively smaller space, and mimic the operation of the conventional sliding-type mouse. Especially the position of the cursor can be precisely and easily controlled.

In one embodiment, the proposed flip-operation mouse device includes a housing, a sliding surface structure, a moving plate, a displacement-detecting device and a control unit. The sliding surface structure includes a first sliding contact surface and is arranged on the housing, so that the first sliding contact surface is exposed to the outer surface of the housing. The moving plate includes a second sliding contact surface arranged on the bottom surface of the moving plate and is placed on the first sliding contact surface with the second sliding contact surface making even and close contact with the first sliding contact surface of the sliding surface structure. The moving plate may slide on the first sliding contact surface with the second sliding contact surface and also move up and down with respect to the housing in the direction perpendicular to the first sliding contact surface. The displacement-detecting device is arranged inside the housing and on the opposite side of the housing with respect to the first sliding contact surface of the sliding surface structure and the moving plate. The displacement-detecting device is used to detect the movement and the direction of the moving plate parallel to and with respect to the first sliding contact surface when the second sliding contact surface of the moving plate is within the effective detecting range. The control unit is arranged inside the housing for processing and putting out the information regarding the parallel movement and direction detected by the displacement-detecting device and operations of other related devices.

The objective, technologies, features and advantages of the present invention will become apparent from the following description in conjunction with the accompanying drawings wherein are set forth, by way of illustration and example, certain embodiments of the present invention.

### BRIEF DESCRIPTION OF THE DRAWINGS

The foregoing conceptions and their accompanying advantages of this invention will become more readily appreciated after being better understood by referring to the following detailed description, in conjunction with the accompanying drawings, wherein:

FIG. 1 is a diagram schematically illustrating the structure of a conventional sliding-type mouse;

FIG. 2a is a cross-sectional view diagram schematically illustrating a flip-operation mouse device according to an embodiment of the present invention;

FIG. 2b is a top view diagram schematically illustrating a flip-operation mouse device according to an embodiment of the present invention;

FIG. 3 is a cross-sectional view diagram schematically illustrating a flip-operation mouse device according to another embodiment of the present invention;

FIG. 4 is a cross-sectional view diagram schematically illustrating a moving plate of flip-operation mouse device according to another embodiment of the present invention;

FIG. 5 is a cross-sectional view diagram schematically illustrating a moving plate of flip-operation mouse device according to yet another embodiment of the present invention; and

FIG. 6 is a diagram schematically illustrating a flip-operation mouse device according to yet another embodiment of the present invention.

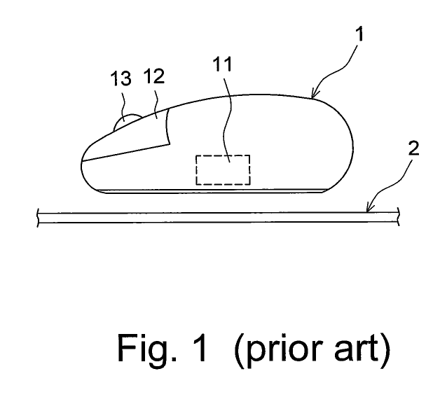

### DESCRIPTION OF THE PREFERRED EMBODIMENT

The detailed explanation of the present invention is described as follows. The described preferred embodiments are presented for purposes of illustrations and description, and they are not intended to limit the scope of the present invention.

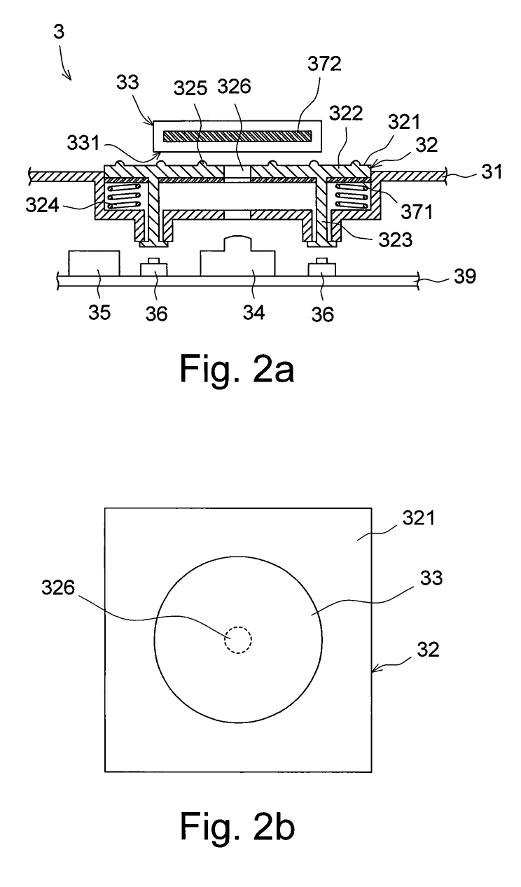

Referring to FIGS. 2a and 2b, in accordance with one embodiment of the flip-operation mouse device 3, comprises a housing 31, a sliding surface structure 32, a moving plate 33, a displacement-detecting device 34 and a control unit 35. The sliding surface structure 32 comprises a first sliding contact surface 321 and is arranged on the housing 31 such that the first sliding contact surface 321 is exposed to the outer surface of the housing 31. The moving plate 33 comprises a second sliding contact surface 331 arranged on the bottom surface of the moving plate 33. The moving plate 33 is placed on the first sliding contact surface 321 with the second sliding contact surface 331 making even and close contact with the first sliding contact surface 321 of the sliding surface structure 32. The moving plate 33 may slide with the second sliding surface 331 parallel to and on the first sliding contact surface 321 and also move up and down with respect to the housing 32 in the direction perpendicular to the first sliding contact surface 321.

The displacement-detecting device 34 is arranged inside the housing 31 and on the opposite side of the housing 31 with respect to the first sliding contact surface 321 and the moving plate 33. The displacement-detecting device 34 is used to detect the movement and direction of the moving plate 33 parallel to and with respect to the first sliding contact surface 321, while the second sliding contact surface 331 of the moving plate 33 stays within the effective detecting range. The control unit 35 is arranged inside the housing 31 for processing and putting out the information regarding the parallel movement and direction detected by the displacement-detecting device 34 and operations of other related devices. For example, the displacement-detecting device 34 and the control unit 35 may be arranged on the circuit board 39 and electrically connected to each other. In one embodiment, the housing 31 comprises a plurality of buttons used for the operations in conjunction with the cursor position control of the flip-operation mouse device 3 and the operations related to computer multimedia functions and special function keys of the computer keyboard. For example, the above-mentioned buttons comprise a left button, a right button and a wheel button, which are arranged on the outer surface of the housing 31 and at the front end and on the opposite side of the housing 31 with respect to the sliding surface structure 32, wherein the wheel button is arranged at the central region between the left button and the right button.

According to the above-mentioned structure, the displacement-detecting device 34 detects the movement and direction of the moving plate 33 parallel to and with respect to the first sliding contact surface 321, whenever the moving plate 33 slides on the first sliding contact surface 321 and stays within the effective detecting range. Furthermore, the first sliding contact surface 321 of the sliding surface structure 32 comprises a plurality of approximately uniformly distributed convex dots or patterns 325 for the moving plate 33 to easily slide on the first sliding contact surface 321. It should be noted that the function of the displacement-detecting device 34 detecting the movement and direction of the moving plate 33 parallel to and relative to the first sliding contact surface 321 may be controlled so that the movement direction in either top-and-bottom or left-and-right can be inverted. Therefore, the user may also place the housing 31, which includes the displacement-detecting device 34 and the rest of the components of the flip-operation mouse device 3, up side down on a fixed surface, for example a desktop, with the first sliding contact surface 321 facing the fixed surface so as to operate the mouse in the conventional way like a sliding-type mouse without requiring the moving plate 33.

Referring to FIG. 2a, the sliding surface structure 32 comprises a first vertically movable plate 322, wherein the first sliding contact surface 321 is arranged on the outer surface of the first vertically movable plate 322 and the first vertically movable plate 322 may move up and down in the direction perpendicular to the first sliding contact surface 321. The second sliding contact surface 331 of the moving plate 33 is arranged making even and close contact with the first sliding contact surface 321 of the first vertically movable plate 322 and moving up and down along with the first vertically movable plate 322 with respect to the housing 31. The flip-operation mouse device 3 may further comprise a set of one or more circuit switches 36 arranged inside the housing 31 and under the sliding surface structure 32. The set of one or more circuit switches 36 is controlled by the up and down movement of the first vertically movable plate 322 of the sliding surface structure 32 for enabling or disabling the displacement-detecting device 34 and the functions and power supplies of other related circuits.

In one embodiment, the first vertically movable plate 322 comprises a plurality of positioning posts 323 and a first elastically-supporting device assembly 324. Both are disposed on the opposite side of the first vertically movable plate 322 with respect to the first sliding contact surface 321. By using the first elastically-supporting device assembly 324 and the plurality of positioning posts 323, the first vertically movable plate 322 of the sliding surface structure 32 is mounted on the housing 31 such that the moving plate 33 can move up and down along with the first vertically movable plate 322 relative to the housing 31 with the driving of the first elastically-supporting device assembly 324 and the pressing down force on the moving plate 33. The plurality of positioning posts 323 are used to fix the horizontal position and to limit the range of up and down movement of the first vertically movable plate 322.

In one embodiment, the first vertically movable plate 322 comprises a first adsorptive element 371 and the moving plate 33 comprises a second adsorptive element 372. The first adsorptive element 371 and the second adsorptive element 372 attracts each other such that the moving plate 33 holds on the first sliding contact surface 321 of the sliding surface structure 32 and maintains still in the position when there is no external force. For example, the first adsorptive element 371 comprises a ferromagnetic lamina and the second adsorptive element 372 comprises a paramagnetic lamina. Similarly, interchanging these two elements would achieve the same function.

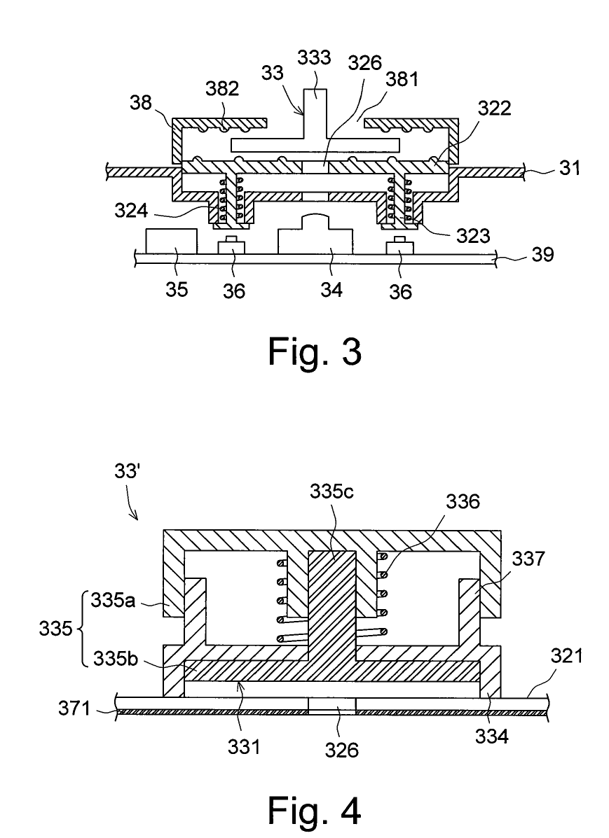

Referring to FIG. 3, the housing 31 comprises a top cover 38 having an opening 381 whose size is smaller than the moving plate 33. The moving plate 33 comprises a bump 333 arranged on the opposite side of the moving plate 33 relative to the second sliding contact surface 331. The moving plate 33 is clipped between the top cover 38 of the housing 31 and the first sliding contact surface 321 of the sliding surface structure 32, and the bump 333 is stuck out of the top cover 38 via the opening 381 and used to drive the moving plate 33 to move. Accordingly, the moving plate 33 may be slid freely on the first sliding contact surface 321 and moved up and down along with the first vertically movable plate 322 of the sliding surface structure 32 relative to the housing 31. In one embodiment, the inner side of the top cover 38 facing the sliding surface structure 32 comprises a plurality of approximately uniformly distributed convex dots or patterns 382 to allow the moving plate 33 to be easily slid underneath the top cover 38. It should be noted that the first elastically-supporting device assembly 324 may also comprise a plurality of springs arranged together with the plurality of positioning posts 323 in an one-to-one corresponding way.

Referring to FIG. 4, in one embodiment, the moving plate 33′ comprises an annular flange 334 surrounding the edge of the second sliding contact surface 331. The second sliding contact surface 331 may be controlled to move up and down relative to the annular flange 334 and also relative to the housing 31 in the direction perpendicular to the first sliding contact surface 321. For example, the moving plate 33′ further comprises a second vertically movable element 335, a second elastically-supporting device 336 and a sliding base 337, wherein the second vertically movable element 335 consists of two separate parts 335a and 335b and comprises the second sliding contact surface 331 and a center axis 335c. The center axis 335c is inserted and embedded in the center hole of the sliding base 337 such that the sliding base 337 is clipped between the two parts, 335a and 335b, and the skirt of the sliding base 337 surrounds the second sliding contact surface 331 to form the annular flange 334. The second elastically-supporting device 336 is used to drive the second vertically movable element 335 to stay at the top position relative to the sliding base 337 limited by the height of the annular flange 334 when the second vertically movable element 335 is not being pressed down. In addition, the second elastically-supporting device 336 drives the second sliding contact surface 331 to move up and down relative to the annular flange 334 by pressing or releasing the second vertically movable element 335. Furthermore, the annular flange 334 of the moving plate 33′ is made of paramagnetic material, while the sliding surface structure comprises a first adsorptive element 371 of ferromagnetic lamina for allowing the moving plate 33′ to attract and hold on the first sliding contact surface 321 of the sliding surface structure 32. Similarly, the annular flange 334 of the moving plate 33′ is made of ferromagnetic material and the first adsorptive element 371 comprises a paramagnetic lamina can also achieve the same function.

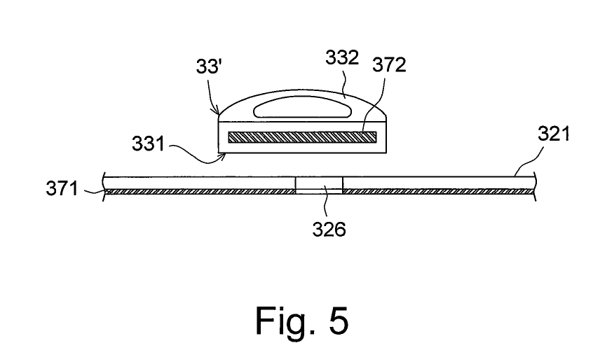

Referring to FIG. 5, in one embodiment, the moving plate 33′ comprises an attaching element 332 arranged on the upper surface opposite to the second sliding contact surface 331 of the moving plate 33. The attaching element 332 is used to attach the moving plate 33 to user's finger for operating the moving plate 33 so as to move around the second sliding contact surface 331 on the first sliding contact surface 321 and move the second sliding contact surface 331 up and down relative to the housing 31. For example, the attaching element 332 comprises a strap loop.

The displacement-detecting device 34 comprises an optical displacement-detector and the sliding surface structure 32 comprises a see-through hole 326 for the optical displacement-detector to detect the movement and direction of the second sliding contact surface 331 of the moving plate 33 and the existence of the second sliding contact surface 331 within the effective detecting range. Alternatively, the displacement-detecting device 34 comprises a rolling-ball displacement-detector and the sliding surface structure 32 comprises a circular opening. The ball of the rolling-ball displacement-detector is configured at the center of the circular opening with a small portion of the ball protruding and plugging up the circular opening. When the second sliding contact surface 331 of the moving plate 33 is pressed down, the moving plate 33 can force the ball of the rolling-ball displacement-detector down and drive the ball to roll through the circular opening so as to detect the movement and direction of the moving plate 33 by measuring the rotation angle and direction of the ball. When the second sliding contact surface 331 of the moving plate 33 is not pressed down, the ball remains in the upper position and protrudes the circular opening and also keeps a small gap between the second sliding contact surface 331 and the top of the ball. Therefore, the functions and power supplies of the rolling-ball displacement-detector and other related circuits can be enabled or disabled by controlling the up and down movement of the ball.

In one embodiment, the flip-operation mouse device of the present invention may be used as a wired mouse, for example, the flip-operation mouse device of the present invention comprises a first computer interface connector, such as the Universal Series Bus (USB) type, for putting out the information processed by the control unit 35. Alternatively, the flip-operation mouse device of the present invention may be used as a wireless mouse, for example, the flip-operation mouse device of the present invention comprises a first wireless transceiver, a battery for providing power and a wireless transceiving adaptor. The wireless transceiving adaptor comprises a second wireless transceiver, a control circuit, a second computer interface connector and a casing, wherein the first wireless transceiver is arranged inside the housing 31 for wirelessly transmitting the information including relative movement and direction of the moving plate 33, button operations and function controls. The control unit 35 controls the function of the first wireless transceiver, the displacement-detecting device 34 and a plurality of buttons, processes the related information, and puts out the processed information to the first wireless transceiver. The second wireless transceiver wirelessly receives information transmitted by the first wireless transceiver. The control circuit is electrically connected to the second wireless transceiver and the second computer interface connector for processing the information received by the second wireless transceiver and putting out the processed information through the second computer interface connector. In an embodiment, the flip-operation mouse device comprises a charging circuit for charging the rechargeable battery.

For example, the first wireless transceiver and the second wireless transceiver respectively comprise a radio frequency transceiver with at least one antenna. Alternatively, the first wireless transceiver comprises an infra red transmitter with at least one infra red light emitting diode and the second wireless transceiver comprises an infra red receiver with at least one infra red sensor. The second computer interface connector may be a USB type.

In one embodiment, the wireless mouse comprising the flip-operation mouse device 3 may include a laser beam transmitting device of the light pointer. One of the plurality of buttons may be used to turn the laser beam transmitting device on or off. Furthermore, the flip-operation mouse device 3 may be configured on the top of the keyboard of a desktop computer, the casing of a notebook computer or the housing of a TV or PC game console so as to integrate the housing 31 with the casing of the keyboard, the notebook computer or the game console, respectively. In this embodiment, the left button, right button and wheel button may be configured on the top, bottom, left or right sides of the sliding surface structure 32.

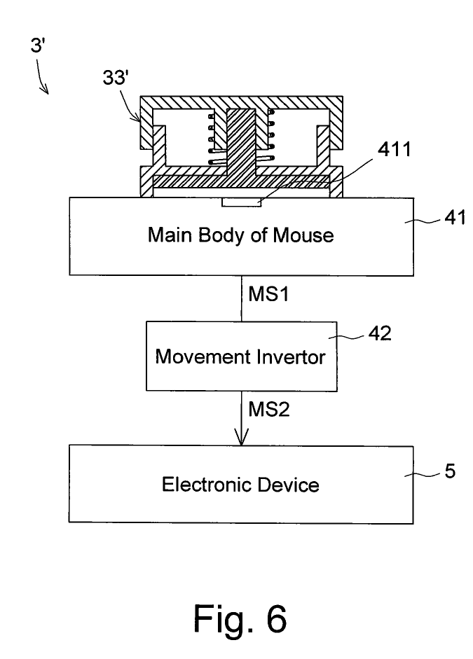

It should be noted that similar flip-operation may be achieved for the conventional sliding-type mouse by sliding the moving plate 33′, illustrated in FIG. 4 or FIG. 5, on the flat area around the displacement-detecting hole. For example, referring to FIG. 6, the flip-operation mouse device 3′ comprises a main body of a mouse 41 and a moving plate 33′. The main body of a mouse 41 is a conventional sliding-type mouse with the displacement-detecting hole 411 facing up while held in hand. The moving plate 33′ is placed with the second sliding contact surface 331 making even and close contact on the flat area around the displacement-detecting hole and may freely move about on and parallel to the flat area around the displacement-detecting hole. In addition, the second sliding contact surface 331 of the moving plate 33′ may move up and down in the direction perpendicular to the flat area around the displacement-detecting hole relative to the main body of a mouse 41.

The flip-operation mouse device 3′ of the present invention further comprises a displacement invertor 42 electrically connected to the signal output terminal of the main body of a mouse 41. The displacement invertor 42 is used to convert the first displacement signal MS1 put out from the main body of a mouse 41 into the second displacement signal MS2 with inverted top-and-bottom or right-and-left direction and unchanged format and send the second displacement signal to the electronic device 5. In this way, the user can convert a conventional sliding-type mouse into a hand-held stationary type mouse and doesn't need to operate it on a fixed surface.

It should be noted that the function of the displacement invertor 42 may be also realized with the software solution. For example, a software driver for the displacement inversion is installed in the electronic device 5 using the main body of a mouse 41 as the cursor control device and used to convert the first displacement signal MS1 sent out from the main body of a mouse 41 into the second displacement signal MS2 with inverted top-and-bottom or right-and-left direction and unchanged format that is delivered to the electronic device 5.

To summarize the foregoing descriptions, the flip-operation mouse device of the present invention provides a moving plate for the user to operate and a stationary displacement-detecting device to detect the movement and direction of the moving plate for controlling the cursor. Therefore, the flip-operation mouse device of the present invention requires less space to operate. Furthermore, by moving the moving plate up and down to turn on or off the displacement-detecting device can enable the operation of the moving plate within a smaller space repetitively, so as to effectively extend the maximum equivalent operation area. With such design the cursor position can be precisely controlled and similar operation as the conventional sliding-type mouse that people are used to can also be adopted.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. A flip-operation mouse device comprising:
a housing;
a sliding surface structure comprising a first sliding contact surface and arranged on said housing so as to expose said first sliding contact surface to the outer surface of said housing;
a moving plate comprising a second sliding contact surface arranged on its bottom surface, being placed on said first sliding contact surface with said second sliding contact surface making even and close contact with said first sliding contact surface of said sliding surface structure, and being able to slide on and parallel to said first sliding contact surface with said second sliding contact surface and also move up and down relative to said housing in the direction perpendicular to said first sliding contact surface;
a displacement-detecting device, arranged inside said housing and on an opposite side of said housing relative to said first sliding contact surface of said sliding surface structure and said moving plate for detecting the movement and direction of said moving plate parallel to and relative to said first sliding contact surface while said second sliding contact surface of said moving plate stays within the effective detection range; and
a control unit, arranged inside said housing for processing and putting out the information regarding the parallel movement and direction detected by said displacement-detecting device and operations of other related devices.

2. The flip-operation mouse device according to claim 1, wherein the function of said displacement-detecting device detecting the movement and direction of said moving plate parallel to and relative to said first sliding contact surface is controlled so that the detected direction is inverted in either top-and-bottom or left-and-right.

3. The flip-operation mouse device according to claim 1, wherein said first sliding contact surface of said sliding surface structure comprises a plurality of approximately uniformly distributed convex dots or patterns.

4. The flip-operation mouse device according to claim 1, wherein said sliding surface structure comprises a first vertically movable plate having said first sliding contact surface arranged on its outer surface and being able to move up and down in the direction perpendicular to said first sliding contact surface; and wherein said second sliding contact surface of said moving plate is arranged making even and close contact with said first sliding contact surface of said first vertically movable plate and is able to move up and down along with said first vertically movable plate relative to said housing.

5. The flip-operation mouse device according to claim 4, wherein said first vertically movable plate comprises a plurality of positioning posts and a first elastically-supporting device assembly arranged on the opposite side of said first vertically movable plate relative to said first sliding contact surface, and is disposed on said housing by using said first elastically-supporting device assembly and said plurality of positioning posts so as to drive said moving plate to move up and down relative to said housing by said first elastically-supporting device assembly and to fix the horizontal position and limit the maximum range of up and down movement of said first vertically movable plate by said plurality of positioning posts.

6. The flip-operation mouse device according to claim 4, wherein said first vertically movable plate comprises a first adsorptive element and said moving plate further comprises a second adsorptive element, said first adsorptive element and said second adsorptive element attracts each other such that said moving plate holds on said first sliding contact surface of said sliding surface structure and maintains still in the position when there is no external force, wherein said first adsorptive element comprises a ferromagnetic lamina and said second adsorptive element comprises a paramagnetic lamina; or said first adsorptive element comprises a paramagnetic lamina and said second adsorptive element comprises a ferromagnetic lamina.

7. The flip-operation mouse device according to claim 4, wherein said housing comprises a top cover including an opening whose size is smaller than said moving plate; said moving plate comprising a bump and being configured between said top cover of said housing and said first sliding contact surface of said sliding surface structure; said bump being stuck out of said top cover via said opening and used to drive said moving plate to move around on said first sliding contact surface of said first vertically movable plate with said second sliding contact surface and to move up and down along with said first vertically movable plate relative to said housing, wherein an inner side of said top cover facing said sliding surface structure further comprises a plurality of approximately uniformly distributed convex dots or patterns.

8. The flip-operation mouse device according to claim 1, wherein said moving plate comprises an annular flange surrounding an edge of said second sliding contact surface that may be controlled to move up and down relative to said annular flange and also relative to said housing in the direction perpendicular to said first sliding contact surface, wherein said annular flange of said moving plate is made of paramagnetic material and said sliding surface structure comprises a first adsorptive element of ferromagnetic lamina so that said first adsorptive element and said annular flange attract each other for said moving plate to attract and hold on said first sliding contact surface of said sliding surface structure and to maintain still in the position when there is no external force; and the material of said annular flange and said first adsorptive element are inter-changeable.

9. The flip-operation mouse device according to claim 8, wherein said moving plate comprises a second vertically movable element, a second elastically-supporting device and a sliding base; said second vertically movable element comprising said second sliding contact surface and a center axis inserted and embedded in the center hole of said sliding base for the skirt of said sliding base to surround said second sliding contact surface to form said annular flange; said second elastically-supporting device being adopted to drive said second vertically movable element to stay at the top position with respect to said sliding base limited by the height of said annular flange when said second vertically movable element is not being pressed down;
said second elastically-supporting device also driving said second sliding contact surface to move up and down relative to said annular flange by pressing or releasing said second vertically movable element.

10. The flip-operation mouse device according to claim 1, wherein said moving plate comprises an attaching element configured on the opposite upper surface of said moving plate relative to said second sliding contact surface for attaching said moving plate to a finger so as to operate said moving plate by the finger for moving around with said second sliding contact surface on said first sliding contact surface and moving said second sliding contact surface up and down relative to said housing, wherein said attaching element comprises a strap loop for ringing the finger so as to operate said moving plate for moving around said second sliding contact surface on said first sliding contact surface and moving said second sliding contact surface up and down relative to said housing.

11. The flip-operation mouse device according to claim 1, wherein said displacement-detecting device comprises a optical displacement-detector and said sliding surface structure comprises a see-through hole for said optical displacement-detector to detect the movement and direction of said second sliding contact surface of said moving plate and the existence of said second sliding contact surface within the effective detecting range.

12. The flip-operation mouse device according to claim 1, wherein said displacement-detecting device comprises a rolling-ball displacement-detector and said sliding surface structure comprises a circular opening; a ball of said rolling-ball displacement-detector being configured at the center of said circular opening with a small portion of said ball protruding and plugging up said circular opening; and wherein when said second sliding contact surface of said moving plate is pressed down, said moving plate presses and drives said ball of said rolling-ball displacement-detector to roll via said circular opening so as to detect the movement and direction of said moving plate by measuring the rotation angle and direction of said ball; when said second sliding contact surface of said moving plate is not pressed, said ball remaining in the upper position and protruding said circular opening and also maintaining a small gap between said second sliding contact surface and the top of said ball; the functions and power supplies of said rolling-ball displacement-detector and other related circuits being enabled or disabled by controlling the up and down movement of said ball.

13. The flip-operation mouse device according to claim 1, being integrally configured on the top of a computer keyboard casing, a notebook computer casing or a TV or computer game console casing so as to become a part of the whole housing, respectively, wherein said sliding surface structure comprises a left button, a right button and a wheel button configured on one of the top, bottom, left, and right sides of said sliding surface structure.

14. The flip-operation mouse device according to claim 1, further comprising a first computer interface connector for putting out information processed by said control unit, said first computer interface connector comprising an USB (Universal Series Bus) connector.

15. The flip-operation mouse device according to claim 1, further comprising a first wireless transceiver, a battery for providing power and a wireless transceiving adaptor, said wireless transceiving adaptor comprising a second wireless transceiver, a control circuit, a second computer interface connector and a casing; wherein said first wireless transceiver is arranged inside said housing for wirelessly transmitting information including relative movement and direction of said moving plate, button operations and function controls; said control unit also controlling the function of said first wireless transceiver and said displacement-detecting device, processing the related information and putting out the processed information to said first wireless transceiver; and wherein said second wireless transceiver is used to wirelessly receive information transmitted by said first wireless transceiver; said control circuit electrically connecting with said second wireless transceiver and said second computer interface connector respectively for processing the information received by said second wireless transceiver and putting out the processed information through said second computer interface connector, said second computer interface connector comprising an USB (Universal Series Bus) connector.

16. The flip-operation mouse device according to claim 15, wherein said first wireless transceiver and said second wireless transceiver comprise respectively a radio frequency transceiver with at least one antenna; or said first wireless transceiver comprises an infra red transmitter with at least one infra red light emitting diode, and said second wireless transceiver comprises an infra red receiver with at least one infra red sensor.

17. The flip-operation mouse device according to claim 16, further comprising a charging circuit and a laser beam transmitting device of the light pointer can be turned on or off with control, wherein said battery comprises a rechargeable battery.

18. The flip-operation mouse device according to claim 16, wherein said housing comprises a plurality of buttons used for the operations in conjunction with the cursor position control of said flip-operation mouse device and the operations of multimedia functions of the computer and special function keys of the computer keyboard; and wherein said control unit also controls the operations and functions of said plurality of buttons and processes the information related to the operations and functions, wherein said plurality of buttons comprise a left button, a right button and a wheel button, configured on an outer surface of said housing and at the front end and on the opposite side of said housing relative to said sliding surface structure, the wheel button being arranged at a central region between said left button and said right button.

19. A flip-operation mouse device comprising:
a main body of a mouse, being a sliding-type mouse including a displacement-detecting hole and a flat area around said displacement-detecting hole, wherein said displacement-detecting hole is facing upward while said main body of a mouse is held in hand;
a moving plate, comprising a sliding contact surface, being placed with said sliding contact surface making even and close contact on said flat area around said displacement-detecting hole, and freely moving about on and parallel to said flat area around said displacement-detecting hole, wherein said sliding contact surface of said moving plate is able to move up and down in the direction perpendicular to said flat area around said displacement-detecting hole relative to said main body of a mouse; and
a displacement invertor electrically connected with a signal output terminal of said main body of a mouse, said displacement invertor converting a first displacement signal put out from said main body of a mouse into a second displacement signal with inverted top-and-bottom or right-and-left direction and unchanged format and then sending said second displacement signal to the output.

20. The flip-operation mouse device according to claim 19, wherein said displacement invertor is realized by a displacement-inverting software driver, and said displacement-inverting software driver is installed in a electronic device using said main body of a mouse as the cursor control device and used to convert a first displacement signal put out from said main body of a mouse into a second displacement signal with inverted top-and-bottom or right-and-left direction and unchanged format and then send said second displacement signal to said electronic device.

21. The flip-operation mouse device according to claim 19, wherein said moving plate further comprises a annular flange surrounding an edge of said sliding contact surface; said sliding contact surface being controlled to move up and down relative to said annular flange and also relative to said main body of a mouse in the direction perpendicular to said flat area around said displacement-detecting hole, wherein said annular flange of said moving plate is made of paramagnetic material and said sliding surface structure comprises a first adsorptive element of ferromagnetic lamina so that said first adsorptive element and said annular flange attract each other for said moving plate to attract and hold on said first sliding contact surface of said sliding surface structure and to maintain still in the position when there is no external force; and the material of said annular flange and said first adsorptive element are inter-changeable.

22. The flip-operation mouse device according to claim 21, wherein said moving plate comprises a vertically movable element, a elastically-supporting device and a sliding base; said vertically movable element comprising said sliding contact surface and a center axis inserted and embedded in the center hole of said sliding base for the skirt of sliding base to surround said sliding contact surface to form said annular flange; said elastically-supporting device being used to drive said vertically movable element to stay at the top position relative to said sliding base limited by the height of said annular flange when said vertically movable element is not being pressed down; said elastically-supporting device also driving said sliding contact surface to move up and down relative to said annular flange and also with respect to said main body of a mouse in the direction perpendicular to said flat area around said displacement-detecting hole by pressing or releasing said vertically movable element.

23. The flip-operation mouse device according to claim 19, wherein said moving plate further comprises an attaching element configured on an upper surface opposite to said sliding contact surface of said moving plate for attaching said moving plate to a finger so as to operate said moving plate by the finger for moving about said the sliding contact surface on and parallel to said flat area around said displacement-detecting hole and moving said sliding contact surface up and down relative to said main body of a mouse in the direction perpendicular to said flat area around said displacement-detecting hole, wherein said attaching device comprises a strap loop for ringing the finger so as to operate said moving plate for moving around said sliding contact surface on and parallel to said flat area around said displacement-detecting hole and moving said sliding contact surface up and down relative to the main body of a mouse in the direction perpendicular to said flat area around said displacement-detecting hole.

24. The flip-operation mouse device according to claim 3, being integrally configured on the top of a computer keyboard casing, a notebook computer casing or a TV or computer game console casing so as to become a part of the whole housing, respectively, wherein said sliding surface structure comprises a left button, a right button and a wheel button configured on one of the top, bottom, left, and right sides of said sliding surface structure.

25. The flip-operation mouse device according to claim 4, being integrally configured on the top of a computer keyboard casing, a notebook computer casing or a TV or computer game console casing so as to become a part of the whole housing, respectively, wherein said sliding surface structure comprises a left button, a right button and a wheel button configured on one of the top, bottom, left, and right sides of said sliding surface structure.

26. The flip-operation mouse device according to claim 5, being integrally configured on the top of a computer keyboard casing, a notebook computer casing or a TV or computer game console casing so as to become a part of the whole housing, respectively, wherein said sliding surface structure comprises a left button, a right button and a wheel button configured on one of the top, bottom, left, and right sides of said sliding surface structure.

27. The flip-operation mouse device according to claim 6, being integrally configured on the top of a computer keyboard casing, a notebook computer casing or a TV or computer game console casing so as to become a part of the whole housing, respectively, wherein said sliding surface structure comprises a left button, a right button and a wheel button configured on one of the top, bottom, left, and right sides of said sliding surface structure.

28. The flip-operation mouse device according to claim 7, being integrally configured on the top of a computer keyboard casing, a notebook computer casing or a TV or computer game console casing so as to become a part of the whole housing, respectively, wherein said sliding surface structure comprises a left button, a right button and a wheel button configured on one of the top, bottom, left, and right sides of said sliding surface structure.

29. The flip-operation mouse device according to claim 8, being integrally configured on the top of a computer keyboard casing, a notebook computer casing or a TV or computer game console casing so as to become a part of the whole housing, respectively, wherein said sliding surface structure comprises a left button, a right button and a wheel button configured on one of the top, bottom, left, and right sides of said sliding surface structure.

30. The flip-operation mouse device according to claim 9, being integrally configured on the top of a computer keyboard casing, a notebook computer casing or a TV or computer game console casing so as to become a part of the whole housing, respectively, wherein said sliding surface structure comprises a left button, a right button and a wheel button configured on one of the top, bottom, left, and right sides of said sliding surface structure.

31. The flip-operation mouse device according to claim 10, being integrally configured on the top of a computer keyboard casing, a notebook computer casing or a TV or computer game console casing so as to become a part of the whole housing, respectively, wherein said sliding surface structure comprises a left button, a right button and a wheel button configured on one of the top, bottom, left, and right sides of said sliding surface structure.

32. The flip-operation mouse device according to claim 11, being integrally configured on the top of a computer keyboard casing, a notebook computer casing or a TV or computer game console casing so as to become a part of the whole housing, respectively, wherein said sliding surface structure comprises a left button, a right button and a wheel button configured on one of the top, bottom, left, and right sides of said sliding surface structure.
